(19) United States
(12) Patent Application Publication
(10) Pub. No.: US 2018/0006534 A1
(43) Pub. Date: Jan. 4, 2018

(54) BLOWER

(71) Applicant: Zhongshan Broad-Ocean Motor Manufacturing Co., Ltd., Zhongshan (CN)

(72) Inventor: Yueqiang YU, Zhongshan (CN)

(21) Appl. No.: 15/705,236

(22) Filed: Sep. 14, 2017

Related U.S. Application Data
(63) Continuation-in-part of application No. PCT/CN2015/090105, filed on Sep. 21, 2015.

(30) Foreign Application Priority Data
Mar. 25, 2015 (CN) 201520176955.2

(51) Int. Cl. H02K 11/00; F04D 17/16; F04D 25/06; H02K 5/16; H02K 5/10; F04D 29/42

(52) U.S. Cl. CPC H02K 11/0094; H02K 5/161; H02K 5/10; F04D 17/16; F04D 25/0693; F04D 29/4226

(57) ABSTRACT

A blower including a volute, a motor, a blower wheel, and a box. The motor is disposed on the volute. The motor includes a spindle, a rotor assembly, a stator assembly, a motor housing, a front-end cover, a rear-end cover and a capacitor. The rotor assembly is disposed on the spindle. The stator assembly and the motor housing are integrated and sleeved on the rotor assembly. The front-end cover and the rear-end cover are installed on the two ends of the motor housing, respectively. Two ends of the spindle are supported on the bearing of the front-end cover and the bearing of the rear-end cover, respectively. The front end of the spindle extends into the volute and is connected to the blower wheel. The capacitor is disposed in a cavity formed by the box and the rear-end cover.

### CROSS-REFERENCE TO RELATED APPLICATIONS

This application is a continuation-in-part of International Patent Application No. PCT/CN2015/090105 with an international filing date of Sep. 21, 2015, designating the United States, now pending, and further claims foreign priority to Chinese Patent Application No. 201520176955.2 filed Mar. 25, 2015. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, and Cambridge, Mass. 02142.

### BACKGROUND OF THE INVENTION

### Field of the Invention

The present disclosure relates to a blower.

### Description of the Related Art

As shown in FIG. 1, a capacitor is disposed on the motor housing 102 of the blower through the capacitor box 101. The structure has at least the following defects:

(1) The capacitor box 101 is disposed on the side of the motor housing 102, thus increasing the lateral dimension of the motor and causing difficulty to assemble.

(2) Since the motor housing 102 is thin, the capacitor box 101 must be welded on the side of the motor housing 102, which is laborious.

(3) The capacitor is connected to the lead wire of the motor via lead wire holes 103, 104 which are disposed on the capacitor box 102 and the motor housing 102, respectively. The lead wire of the capacitor runs through the lead wire holes 103 and 104 and then is connected to the lead wire of the motor. The connection mode is complex, reducing the assembling efficiency and making it more difficult to obtain a good seal.

### SUMMARY OF THE INVENTION

In view of the above-described problems, it is one objective of the invention to provide a blower that has a compact structure, which facilitates the assembly of a capacitor, and features a good seal.

To achieve the above objective, in accordance with one embodiment of the invention, there is provided a blower comprising a volute, a motor, a blower wheel, and a box. The motor is disposed on the volute. The motor comprises a spindle, a rotor assembly, a stator assembly, a motor housing, a front-end cover, a rear-end cover and a capacitor. The rotor assembly is disposed on the spindle. The stator assembly and the motor housing are integrated and sleeved on the rotor assembly; the front-end cover and the rear-end cover are installed on two ends of the motor housing, respectively. The front-end cover and the rear-end cover are installed on the two ends of the motor housing, respectively. Two ends of the spindle are supported on a bearing of the front-end cover and a bearing of the rear-end cover, respectively. A front end of the spindle extends into the volute and is connected to the blower wheel. The box is disposed on the rear-end cover. The capacitor is disposed in a cavity formed by the box and the rear-end cover.

In a class of this embodiment, the box comprises a cavity part and a turnup part extending out from an end of the cavity part; the capacitor is positioned in the cavity part.

In a class of this embodiment, a ring-shaped gasket is disposed between the turnup part and the rear-end cover.

In a class of this embodiment, the turnup part, the gasket and the rear-end cover are locked and fixed together through a plurality of bolts.

In a class of this embodiment, the front-end cover and the rear-end cover are respectively disposed on the two ends of the motor housing through bolts and nuts.

In a class of this embodiment, first gaps and second gaps are respectively disposed on the outer edges of the turnup part and the gasket and correspond to each other. The nuts are disposed in the first gaps and the second gaps.

In a class of this embodiment, a lead wire hole is disposed on the rear-end cover.

Advantage of the blower according to embodiment of the invention are summarized as follows:

(1) The box is disposed on the rear-end cover. The capacitor is disposed in the cavity formed by the box and the rear-end cover, simplifying the installation of the capacitor; and the structure of the motor is more compact and features good sealing properties.

(2) A ring-shaped gasket is disposed between the turnup part and the rear-end cover to prevent dust, water or other impurities from entering the inside of the motor from the gap between the box and the motor, effectively guaranteeing the tightness of the installation, and preventing electronic parts in the motor from being polluted and damaged.

(3) The turnup part, the gasket and the rear-end cover are locked and fixed together through a plurality of bolts. The installation method is simple, firm, and efficient.

(4) First gaps and second gaps corresponding to the first gaps are respectively disposed on the outer edges of the turnup part and the gasket. The nuts are disposed in the first gaps and the second gaps. The structure is simple facilitates the installation of the blower.

(5) A lead wire hole is disposed on the rear-end cover. The wire of the capacitor runs through the lead wire holes and then is connected to the lead wire of the motor. The wiring is easy to operate. At the same time, the tightness of the motor is guaranteed.

### BRIEF DESCRIPTION OF THE DRAWINGS

FIG. 1 is a stereogram of a blower in the prior art;

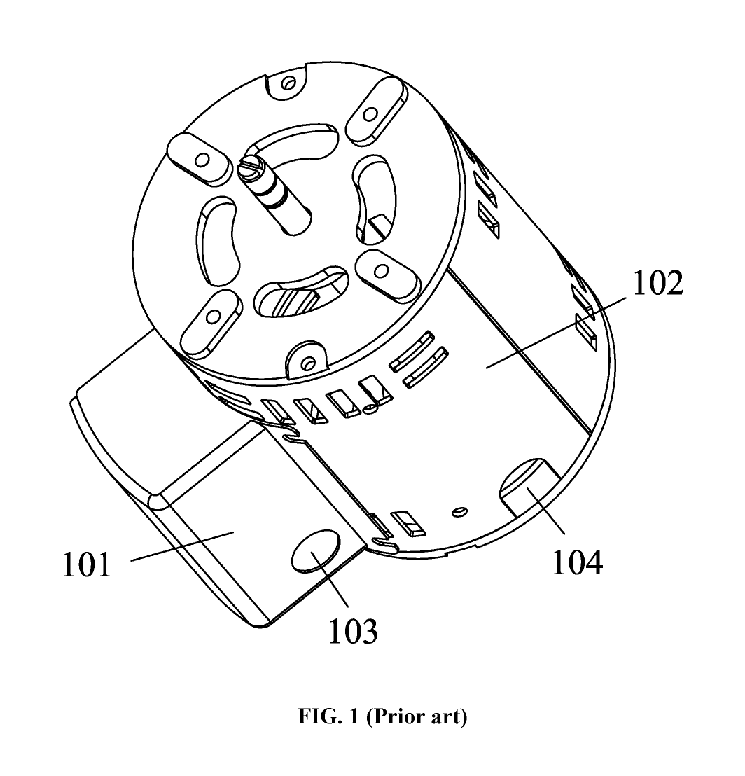

FIG. 2 is a stereogram of a blower in accordance to one embodiment of the invention;

FIG. 3 is an exploded view of a blower in accordance to one embodiment of the invention;

FIG. 4 is an exploded view of a motor in accordance to one embodiment of the invention;

FIG. 5 is a side view of a motor in accordance to one embodiment of the invention; and

FIG. 6 is a sectional view of part VI-VI in FIG. 5.

### DETAILED DESCRIPTION OF THE EMBODIMENTS

For further illustrating the invention, experiments detailing a blower are described below. It should be noted that the following examples are intended to describe but not to limit the invention.

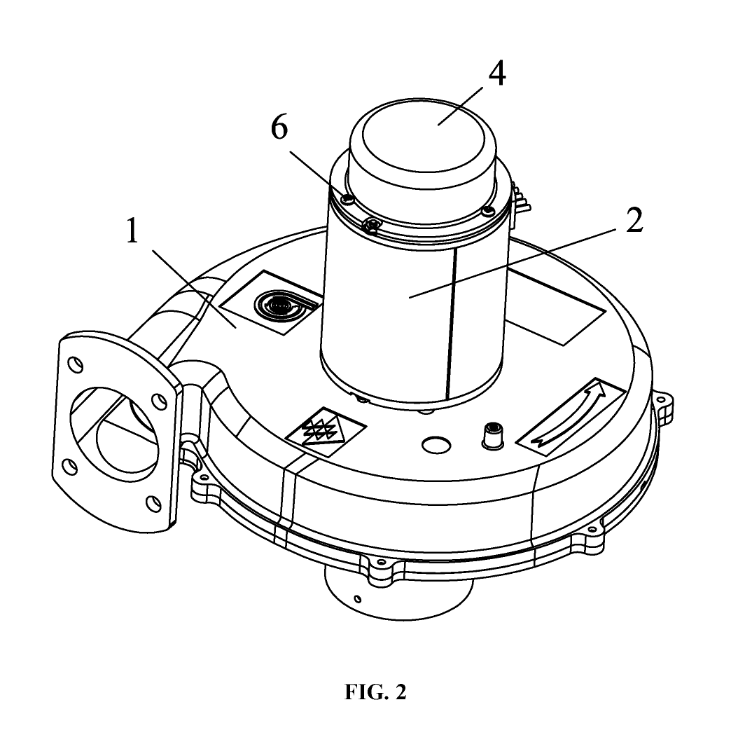

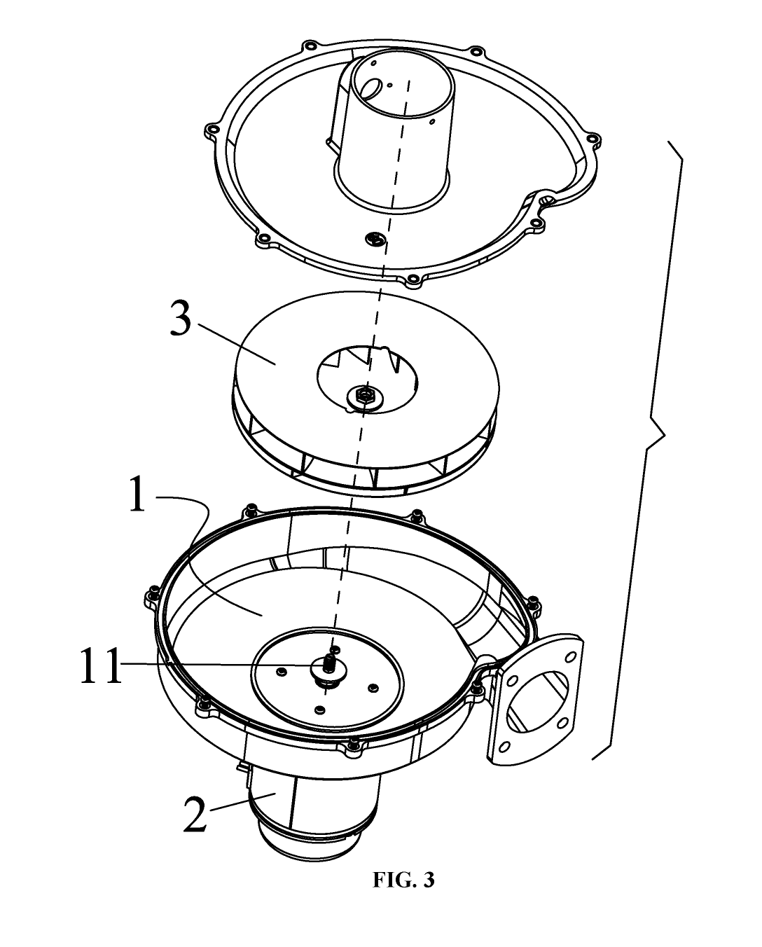

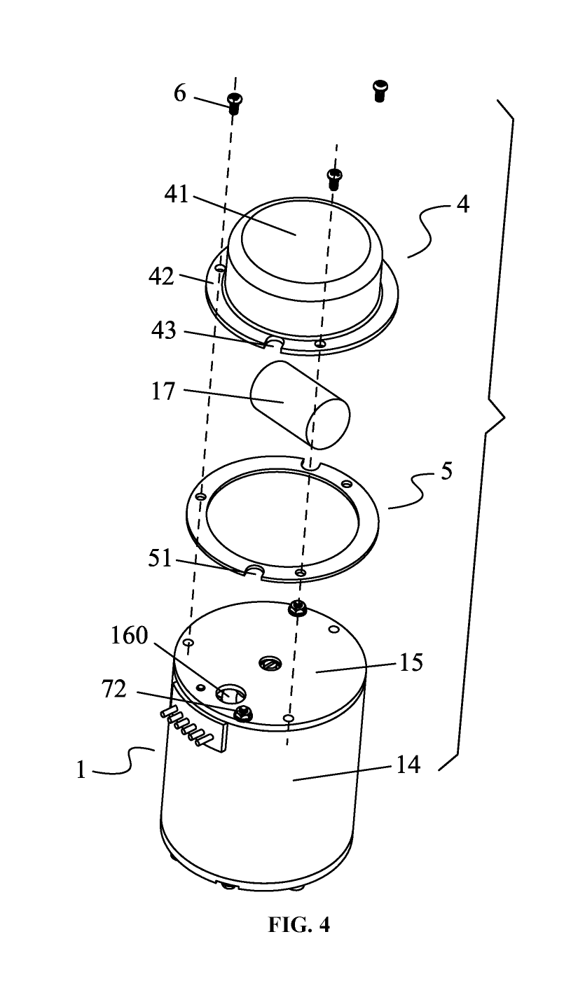

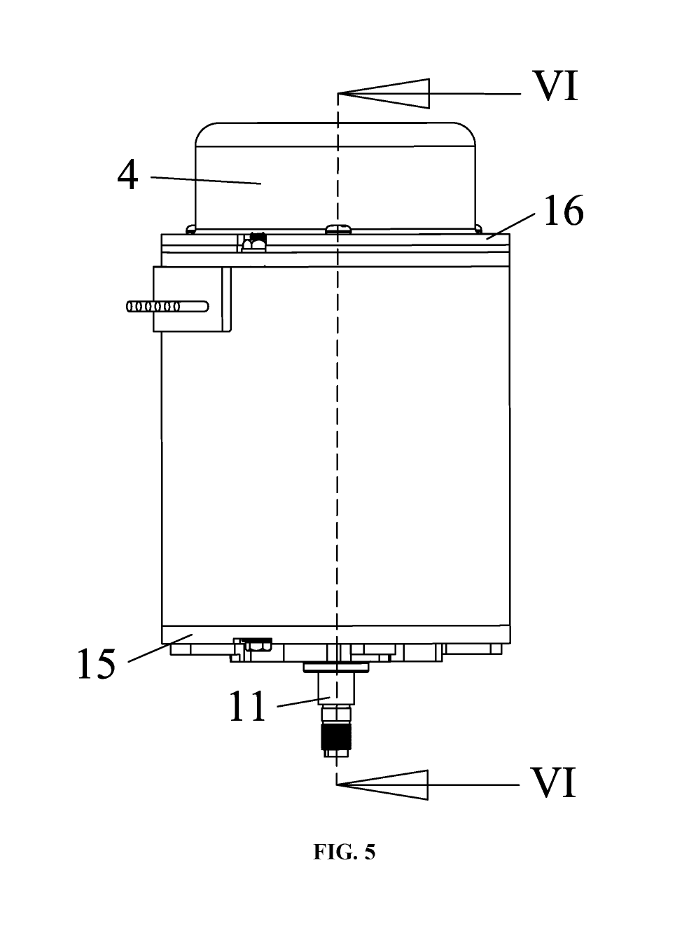

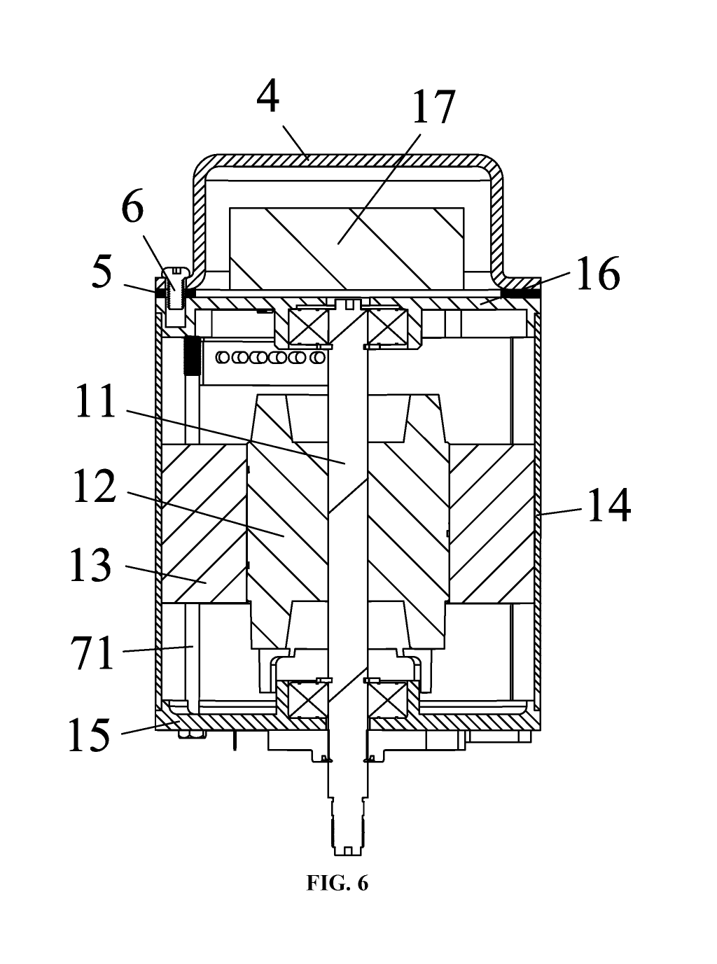

As shown in FIGS. 2, 3, 4, 5 and 6, a blower comprises a volute 1, a motor 2 and a blower wheel 3. The motor 2 is disposed on the volute 1, and comprises a spindle 11, a rotor assembly 12, a stator assembly 13, a motor housing 14, a front-end cover 15, a rear-end cover 16 and a capacitor 17. The rotor assembly 12 is disposed on the spindle 11. The stator assembly 13 and the motor housing 14 are integrated and sleeved on the rotor assembly 12. The front-end cover 15 and the rear-end cover 16 are disposed on two ends of the motor housing 14, respectively. The two ends of the spindle 11 support the bearing of the front-end cover 15 and the bearing of the rear-end cover 16 respectively. The front end of the spindle 11 extends into the volute 1 and is connected to the blower wheel 3. The box 4 is disposed on the rear-end cover 16.

The capacitor 17 is disposed in the cavity formed by the box 4 and the rear-end cover 16. The box 4 comprises a cavity part 41 and a turnup part 42 extending out from the end of the cavity part. The capacitor 17 is positioned in the cavity part 41. A ring-shaped gasket 5 is disposed between the turnup part 42 and the rear-end cover 16. The turnup part 42, the gasket 5 and the rear-end cover 16 are locked and fixed together through a plurality of bolts 6. The front-end cover 15 and the rear-end cover 16 are respectively disposed on the two ends of the motor housing 14 through bolts 71 and nuts 72. First gaps 43 and second gaps 51 corresponding to the first gaps are respectively disposed on the outer edges of the turnup part 42 and the gasket 5 and correspond to each other. The nuts 72 are disposed in the first gaps 43 and the second gaps 51. A lead wire hole 160 is disposed on the rear-end cover 16.

Unless otherwise indicated, the numerical ranges involved in the invention include the end values. While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A blower, comprising:
a volute;
a motor, the motor being disposed on the volute and comprising a spindle, a rotor assembly, a stator assembly, a motor housing, a front-end cover, a rear-end cover, and a capacitor;
a blower wheel; and
a box;
wherein
the rotor assembly is disposed on the spindle;
the stator assembly and the motor housing are integrated and sleeved on the rotor assembly;
the front-end cover and the rear-end cover are installed on two ends of the motor housing, respectively;
two ends of the spindle are supported on a bearing of the front-end cover and a bearing of the rear-end cover, respectively;
a front end of the spindle extends into the volute and is connected to the blower wheel;
the box is disposed on the rear-end cover; and
the capacitor is disposed in a cavity formed by the box and the rear-end cover.

2. The blower of claim 1, wherein the box comprises a cavity part and a turnup part extending out from an end of the cavity part; the capacitor is positioned in the cavity part.

3. The blower of claim 2, wherein a ring-shaped gasket is disposed between the turnup part and the rear-end cover.

4. The blower of claim 3, wherein the turnup part, the gasket and the rear-end cover are locked and fixed together through a plurality of bolts.

5. The blower of claim 2, wherein the front-end cover and the rear-end cover are respectively disposed on two ends of the motor housing through bolts and nuts.

6. The blower of claim 3, wherein the front-end cover and the rear-end cover are respectively disposed on two ends of the motor housing through bolts and nuts.

7. The blower of claim 4, wherein the front-end cover and the rear-end cover are respectively disposed on two ends of the motor housing through bolts and nuts.

8. The blower of claim 5, wherein first gaps and second gaps corresponding to the first gaps are respectively disposed on outer edges of the turnup part and the gasket; and the nuts are disposed in the first gaps and the second gaps.

9. The blower of claim 6, wherein first gaps and second gaps corresponding to the first gaps are respectively disposed on outer edges of the turnup part and the gasket; and the nuts are disposed in the first gaps and the second gaps.

10. The blower of claim 7, wherein first gaps and second gaps corresponding to the first gaps are respectively disposed on outer edges of the turnup part and the gasket; and the nuts are disposed in the first gaps and the second gaps.

11. The blower of claim 1, wherein a lead wire hole is disposed on the rear-end cover.

12. The blower of claim 2, wherein a lead wire hole is disposed on the rear-end cover.

13. The blower of claim 3, wherein a lead wire hole is disposed on the rear-end cover.

14. The blower of claim 4, wherein a lead wire hole is disposed on the rear-end cover.
